(19) United States
(12) Patent Application Publication
(10) Pub. No.: US 2010/0022225 A1
(43) Pub. Date: Jan. 28, 2010

(54) METHODS AND SYSTEMS FOR SETTING, SCHEDULING, OPTIMIZING, AND INITIATING PERSONAL COMMUNICATION AND PRIORITIZING COMMUNICATION CHANNELS AND DEVICES

(75) Inventors: Dan Benger, Emek- Hefer (IL); Ram Halfi, Shoham (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: NEATCALL LTD., Netanya, IL (US)

(21) Appl. No.: 12/441,905

(22) PCT Filed: Oct. 29, 2007
(86) PCT No.: PCT/IL07/01309

§ 371 Date: Mar. 19, 2009

Related U.S. Application Data
(60) Provisional application No. 60/863,368, filed on Oct. 29, 2006.

(51) Int. Cl. H04M 3/42

(52) U.S. Cl. 455/414.1

(57) ABSTRACT

The present invention discloses methods for electronically organizing an event among users having personal communication devices (PCDs), the method including the steps of: providing event details, defined by an initiator, of the event to a control unit, wherein the event details designate invited users and at least one suggested event time; transmitting, by the control unit, the event details in an event request to the invited users; indicating intentions, using the PCDs, of the invited users to participate in the event in responses from the invited users; designating, using the PCDs, a compatibility of the suggested event time with the invited users in the responses; dynamically interacting, by the control unit, with the initiator and the invited users to find an optimal event time; and conveying, by the control unit, the responses in a response report, wherein the response report indicates the optimal event time to the initiator.

### FIELD AND BACKGROUND OF THE INVENTION

The present invention relates to methods and systems for scheduling, initiating and conducting, and tracking the timing of, on-line communication using any kind of personal communication device (e.g. via cellular phones, telephones, smart phones, computers, and mobile devices) and face-to-face gathering (e.g. conversation, meeting, conferencing, chat, and social events).

Those skilled in the art of electronic commerce (eC), business to business commerce (B2B), mobile commerce (mC), on-line conference (oC), mobile software (mS), wireless software (wS), or chat software know that communication between people via PCDs (personal communication devices) can be done using two main approaches: (1) by a so-called “try-and-trail” process as depicted in FIG. 1A (e.g. contacting each user via a phone call to the user, sending instant messaging services, short messages service (SMS), multimedia service (MMS), or e-mail) in order to find out if those users are ready to be engaged in the specific call or event; and (2) by designating a scheduled time in advance for the event, and asking all users to join at the scheduled time (e.g. by a conference bridge), or reserving the appointment in a scheduling calendar (e.g. Microsoft Outlook, Google Calendar, and IBM Lotus Notes). In FIG. 1, an initiator 2 uses a cellular phone to call (via channels 4), invite, and schedule other users to participate in the event.

In the prior art, Jefferson et al, US Patent Publication No. 20060288099 A1 (hereinafter referred to as Jefferson '099), teaches a method and system for presence management in telecommunications for responding to inquiries regarding user presence with respect to various communication systems. Nelken, WO Patent Publication No. WO2006092790 (hereinafter referred to as Nelken '790), teaches an automatic scheduling method and apparatus for scheduling activities between users having on-line calendar information available to a network. Wu, U.S. Pat. No. 6,275,575 B1 (hereinafter referred to as Wu '575), teaches a method and system for coordinating and initiating cross-platform telephone conferences.

None of the prior-art systems mentioned above actively perform a dynamic priority-based scheduling procedure with the designated parties, nor does the prior art. offer a scheduling and initiating mechanism for the mobile and cellular phone environment. Such a procedure is necessary for situations in which an initiator wants to conduct communication with one or more users, and does not want to spend time to contact each user separately, or to deal with different time slot options per user. Furthermore, the initiator does not want to send a message that the initiator cannot use to manage the received answers regarding users' time availability and personal willingness to join the event. It can take an initiator an hour or more to schedule an event, even if the initiator wants to have just a short call. Moreover, none of the prior-art systems mentioned above actively set and schedule phone calls, one-on-one conversations, and conferences, initiated by mobile phones and cellular phones with or without access to the internet.

It would be desirable to have methods and systems for setting, scheduling, optimizing, and initiating personal communication, and prioritizing communication channels and devices that overcome the limitations of the prior art as described above.

### SUMMARY OF THE INVENTION

It is the purpose of the present invention to provide methods and systems for setting, scheduling, optimizing, and initiating personal communication, and prioritizing communication channels and devices.

For the purpose of clarity, several terms which follow are specifically defined for use herein. The terms “PCD” and “personal communication device” are used herein to refer to any kind of communication device that is known in the art such as but not limited to a cellular phone, smart phone, mobile phone, blackberry phone, wired phone, personal digital assistant (PDA), pocket PC, mobile PC, and desktop PC. The term “server” is used herein to refer to a computer system that provides services to other computing and communication systems. The term “user” is used herein to refer to any person that uses a PCD. The term “initiator” is used herein to refer to a user that registers into the system, and subsequently, can initiate any kind of communication.

The terms “invited user” and “IU” are used herein to refer to a user that has been invited to any communication initiated by the initiator. The terms “communication”, “interaction”, “collaboration”, “meeting”, “call”, and “event” are used herein interchangeably to refer to any kind of communication that take place between people, such as but not limited to on-line one-on-one conversation, multi-user voice/web/data/video conferencing, chatting, instant-message sharing, and sending by users that use PCDs, or any kind of communication that take place between people in “face-to-face” one-on-one, multi-user, meetings or gatherings (e.g. conference-room meeting, seminar, team meeting, interview, group brainstorming, movie, board meeting, social event, and business event). The terms “dynamic responses shared mechanism” and “DRSM” are used herein to refer to a mechanism by which invited users' responses are generated in a shared template/window by all invited users. The system will try to find an optimal match between the suggested scheduling framework by initiator and the invited users' responses.

The term “connection” is used herein to refer to any kind of networking link between PCDs and/or servers such as but not limited to TCP/IP, UMTS, UMTS-TDD, GSM, CDMA, PSTN, TDMA, GPRS, Bluetooth, dial-up, ISDN, DSL, cable, fiber optic, power-line internet, SIP, H323, ISDN, IEEE 802.11, WiBro, WiMAX, HSDPA, EV-DO, satellite, and Wi-Fi. The term “message” is used herein to refer to a textual or verbal message that is exchanged between users via PCDs. The term “location” is used herein to refer to a communication channel that users use during an event (e.g. cellular phone over a wireless network, PC over an IP network, Blackberry over an IP network, wired telephone over a PSTN network, smart phone via a Wi-Fi network, and face-to-face in an office or outdoors).

The term “SyncML” stands for Synchronization Markup Language. The term “PIM” stands for Personal Information Manager. The term “SLA” stands for service level agreement. The term “GUI” stands for Graphical User Interface (ie. a graphics-based user interface). The term “IVR” stands for interactive voice response which is an automated telephone information-system that speaks to the caller with a combination of fixed-voice menus and data extracted from databases in real-time. The term “DTMF” stands for dual-tone multi-frequency signaling.

The term “ad-hoc” is used herein to refer to a spontaneous, immediate, or instant invitation to an event that can take place shortly after an event request is sent without setting any event time (e.g. an immediate phone-call event). The term “delay time” is used herein to refer to a time for which the event can start no later than. The term “upon-free event time” is used herein to refer to a time when a user, who is currently involved in a call, becomes available. The term “PCD status” is used herein to refer to the status of a user's PCD (e.g. PCD busy, PCD off, PCD non-responsive, PCD available, PCD unavailable, PCD on-vacation, PCD ready-to-receive, PCD in-meeting, PCD abroad, PCD home, and PCD driving). The term “accept call” is used herein to refer to a user accepting a call. The term “delayed-accept call” is used herein to refer to a user accepting a call after a specified amount of time has elapsed from responding (e.g. X minutes from now). The term “upon-free call” is used herein to refer to a user accepting a call after the user, who is currently involved in a call, becomes available.

Embodiments of the present invention facilitate the coordination and initiation of interactions, primarily, but not limited to, calls by mobile phones, much easier and faster than in current state-of-the-art systems. Embodiments of the present invention allow users to speak, chat, share, view, and/or meet each other without wasting time coordinating phone calls, scheduling meetings or conferences, missing calls, receiving unwanted calls, and waiting for calls at inconvenient times. An essential and novel feature of the present invention is the timing optimization of simple phone calls, either one-on-one or multi-user conference, among other types of events.

FIG. 2 is a simplified illustration of a conference initiation and optimization system, according to preferred embodiments of the present invention. In contrast to the prior-art configuration shown in FIG. 1, after the initiator has entered the suggested event details into an initiator PCD 6, initiator PCD 6 contacts a server 8. Server 8 acts as the hub for handling the coordination and execution of an event as opposed to the event initiator. Another significant difference from the prior-art scheme is that the present invention allows channels 4 to include many different communication means to communicate (e.g. to access, optimize, and select) with many types of IU PCDs 10, as shown in FIG. 2.

Typically, an initiator wants an event to take place as close as possible to the moment he/she decides to initiate the event. Since there are many communication channels 4 and PCDs 10 (e.g. wired telephones, cellular phones, smart phones, PDA, and PC) and many communication applications (e.g. simple one-on-one conversation, voice conferencing, instant messengers, voice-over-IP (VoIP), web conferencing, and video conferencing), the initiator cannot pick the channel, device, and application that the invited users prefer or are available.

FIG. 3 is a feature chart showing examples of the variables that the system can use to optimize event scheduling, according to preferred embodiments of the present invention. The system provides a mechanism for automatic scheduling of a conference (Feature 12) that analyzes different variables in order to optimize the communication between the IUs who are about to take part in the event.

Some of the features the system enables include: automatically initiate conversation or conference (Feature 14), interact with IU to set event time via DRSM (Feature 16), utilize IUs' open calendar slots (Feature 18), factor event load into scheduling decision (e.g. if a conference bridge is already heavily loaded, the system can open a new bridge) (Feature 20), and prioritize platforms (e.g. the pre-event configuration can set the platform to be used during the event, for example, cellular phones, but the system can optimize the platform selection by checking the IUs preferences) (Feature 22).

Additional features shown in FIG. 3 include: prioritize by communication costs (e.g. if there is an IU that can connect both via PSTN and IP, the system will channel the IU to use the IP in order to save costs; this is performed by pinging the end-user application, and detecting the available networks and the communication route costs) (Feature 24), prioritize IUs' slots (i.e. IUs can set their own priority) (Feature 26), hide IUs' slots from other users (i.e. for privacy, an IU's open calendar slots can be shared or hidden from other IUs) (Feature 26), and mark different platforms to be available at different times (Feature 30).

Embodiments of the present invention utilizes scheduling efficiency and location prioritization in order to coordinate a scheduled event among people that want to communicate with each other without wasting time and resources on scheduling the event. Such communication can be a one-on-one event (e.g. a conversation between two people over the phone) or a multi-user event (e.g. a conference or meeting with many users).

Therefore, according to the present invention, there is provided for the first time a method for electronically organizing an event among users having personal communication devices (PCDs), the method including the steps of: (a) providing event details, defined by an initiator, of the event to a control unit, wherein the event details designate invited users and at least one suggested event time; (b) transmitting, by the control unit, the event details in an event request to the invited users; (c) indicating intentions, using the PCDs, of the invited users to participate in the event in responses from the invited users; (d) designating, using the PCDs, a compatibility of the suggested event time with the invited users in the responses; (e) dynamically interacting, by the control unit, with the initiator and the invited users to find an optimal event time; and (f) conveying, by the control unit, the responses in a response report, wherein the response report indicates the optimal event time to the initiator.

Preferably, the event details further include at least one detail selected from the group consisting of: an event location, a preferred event type, a reminder time, a delay time, an invited-users list, an event location map, an attached document, an event-related media item, an event length, an event priority, and the responses, a preferred application, an available network, invited-user contact information, an event duration, a critical-participant list, an invited-user attendance priority, and a speaker-designation list.

Preferably, at least one suggested event time includes at least one time option selected from the group consisting of: a fixed time, a time-slot interval, a selection of times, and an ad-hoc event time, an upon-free event time.

Preferably, the step of designating compatibility includes providing a ranking of at least one suggested event times.

Preferably, the step of designating compatibility includes providing at least one alternative event time.

Preferably, the responses include at least one item selected from the group consisting of: a preferred communication channel, a preferred PCD, a alternative-time ranking, a suggested alternative time, free text, a voice memo, an alternative location, invited-user presence information, invited-user contextual information, an invited-user current status, and a preferred network.

Preferably, the step of transmitting includes transmitting using at least one transmittal item selected from the group consisting of: an SMS message, an MMS message, an e-mail message, an http packet, a tcp packet, a udp packet, a voice message, a video message, and an instant-messenger message.

Preferably, the responses are shared with all invited users upon being received by the control unit.

Preferably, the method further includes the step of: (g) automatically activating a spontaneous response template, to be sent to the initiator, for a spontaneous invitee that is contacted, directly by the initiator, without an event request.

Preferably, the method further includes the step of: (g) optimizing the event time based on an algorithm that factors in at least one response item from the responses.

Preferably, the method further includes the step of: (g) prioritizing at least one communication channel for the event based on an algorithm that factors in at least one channel status.

Preferably, the step of interacting includes analyzing at least one factor selected from the group consisting of: the responses, invited-user histories, invited-user presence information, invited-user contextual information, invited-user speed, invited-user location, invited-user PCD data.

Preferably, the method further includes the step of: (g) dynamically interacting with the initiator and the invited users to find an optimal event location.

Preferably, the method further includes the step of: (g) notifying the invited users that the event is about to start.

Preferably, the method further includes the step of: (g) recording, by the control unit, content from the event.

Preferably, the control unit is a device selected from the group consisting of: a system server and a PDC-installed client module.

Preferably, the method further includes the step of: (g) presenting a map location for the event upon selecting a face-to-face event in the event details.

Preferably, the method further includes the step of: (g) updating, by the control unit, the initiator of a PCD status of an invited user, wherein the PCD status is selected from the group consisting of: PCD busy, PCD off, PCD non-responsive, and PCD available, PCD unavailable, PCD on-vacation, PCD ready-to-receive, PCD in-meeting, PCD abroad, PCD home, and PCD driving.

Most preferably, the spontaneous response template includes at least one response option selected from the group consisting of: accept call, delayed-accept call, and upon-free call.

According to the present invention, there is provided for the first time a computer-readable storage medium having computer-readable code embodied on the computer-readable storage medium, the computer-readable code including: (a) program code for providing event details, defined by an initiator, of an event to a control unit, wherein the event details designate invited users and at least one suggested event time; (b) program code for transmitting, by the control unit, the event details in an event request to the invited users; (c) program code for indicating intentions, using PCDs, of the invited users to participate in the event in responses from the invited users; (d) program code for designating, using the PCDs, a compatibility of the suggested event time with the invited users in the responses; (e) dynamically interacting, by the control unit, with the initiator and the invited users to find an optimal event time; and (f) program code for conveying, by the control unit, the responses in a response report, wherein the response report indicates the optimal event time to the initiator.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1 is a simplified illustration of the current situation for initiating a conference, according to the prior art;

FIG. 2 is a simplified illustration of a conference initiation and optimization system, according to preferred embodiments of the present invention;

FIG. 3 is a feature chart showing examples of the variables that the system can use to optimize event scheduling, according to preferred embodiments of the present invention;

FIG. 4 is a simplified schematic block diagram of the high-level system architecture, according to preferred embodiments of the present invention;

FIG. 5 is a simplified illustration of exemplary application menus for a mobile phone as the PCD, according to preferred embodiments of the present invention;

FIG. 6 is a simplified flowchart of the main processes in the system flow, according to preferred embodiments of the present invention;

FIG. 7 is a simplified block diagram of the main modules of the system server, according to preferred embodiments of the present invention;

FIG. 8 is a simplified scheme showing the five layers of processing while setting up an event, according to preferred embodiments of the present invention;

FIG. 9 is a simplified illustration of main use cases, according to preferred embodiments of the present invention;

FIG. 10 is a simplified flowchart of the process steps for an initiator creating an event, according to preferred embodiments of the present invention;

FIG. 11 is a simplified flowchart of the process steps for an IU receiving an event request, according to preferred embodiments of the present invention;

FIG. 12 is a simplified flowchart of the process steps for an IU receiving an ad-hoc event request, according to preferred embodiments of the present invention;

FIG. 13 is a simplified flowchart of the process steps for the server handling an ad-hoc event request, according to preferred embodiments of the present invention;

FIG. 14 is a simplified flowchart of the process steps for the server scheduling an event, according to preferred embodiments of the present invention;

FIG. 15 is a simplified flowchart of the process steps of an optimal-time algorithm for setting an ad-hoc event, according to preferred embodiments of the present invention;

FIG. 16 is a simplified flowchart of the process steps for an optimal-channel algorithm for transmitting messages to users, according to preferred embodiments of the present invention;

FIG. 17 is a simplified flowchart of the process steps for the server scheduler, according to preferred embodiments of the present invention;

FIG. 18 is a simplified flowchart of the process steps for the server handling an event response, according to preferred embodiments of the present invention;

FIG. 19 is a simplified flowchart showing an example of the dynamic event-setting process of the system, according to preferred embodiments of the present invention.

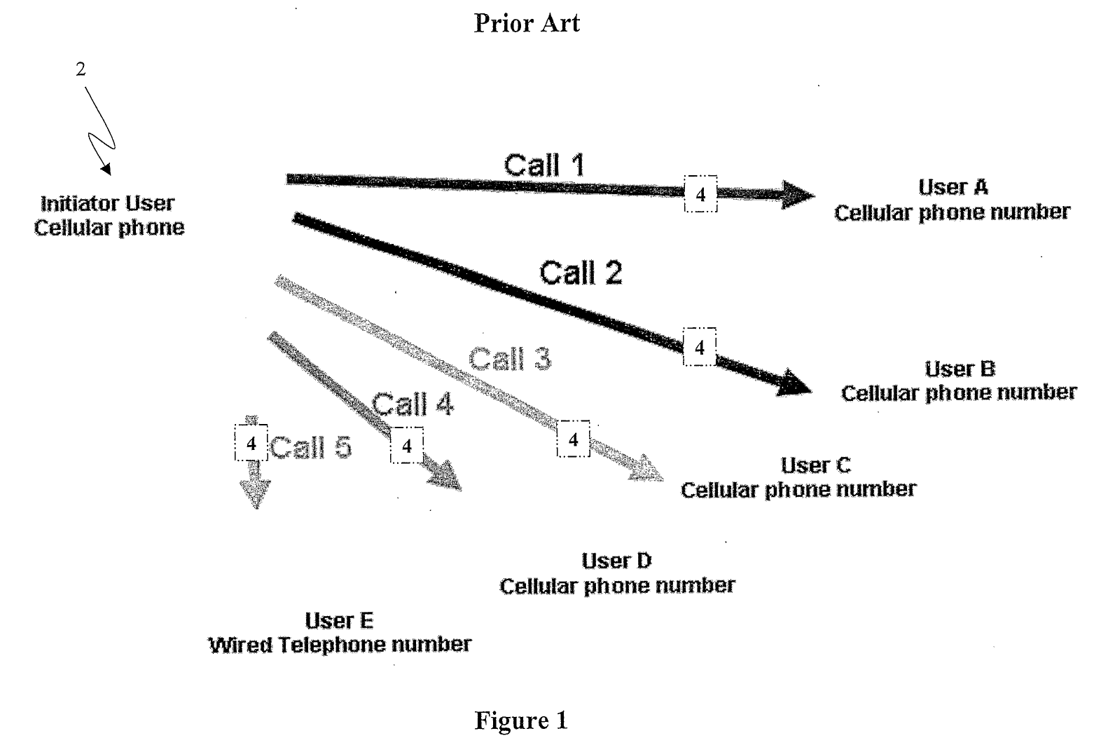

### DESCRIPTION OF THE PREFERRED EMBODIMENTS

The present invention relates to methods and systems for setting, scheduling, optimizing, and initiating personal and multi-user communication, and prioritizing communication channels and devices. The principles and operation for such methods and systems, according to the present invention, may be better understood with reference to the accompanying description and the drawings.

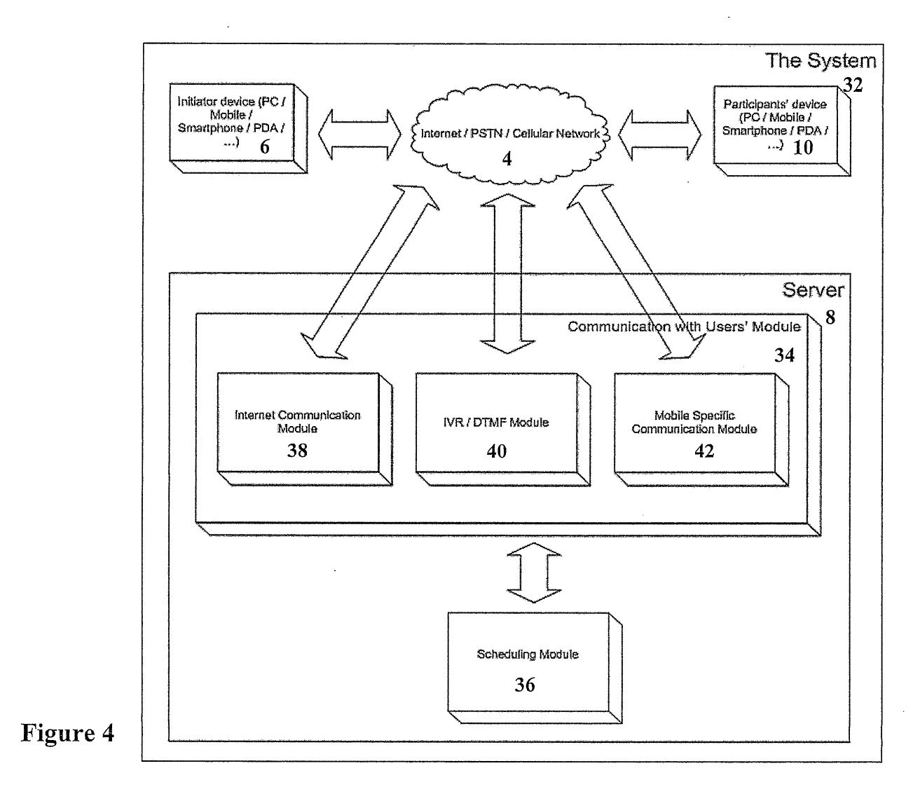

Referring now to the drawings, FIG. 4 is a simplified schematic block diagram of the high-level system architecture, according to preferred embodiments of the present invention. A system 32 allows the initiator to use initiator PCD 6 to communicate, via channels 4, to IU PCDs 10 and server 8. Server 8 includes a user-communication module 34 and a scheduling module 36. User-communication module 34 includes an internet-communication module 38, an IVR/DTMF module 40, and a device-specific communication module 42. System 32 enables the initiator to set and coordinate an event, for communication among IUs, based on server 8 interacting and messaging with the initiator and IUs to find the optimal event time and location for all IUs. It should be noted that the present invention can be implemented without a main server 8 (e.g. the application installed on IU PCDs 10 communicates directly via channels 4). The various modules are described in more detail below.

System 32 optimizes the event time and location based on the IUs' responses, as opposed to existing, accessible calendar information or unmanaged try-and-try interaction. System 32 supports all channels 4 and PCDs 10 that are known in the art. System 32 operates on system software installed in server 8 and end-user software applications installed in PCDs 10.

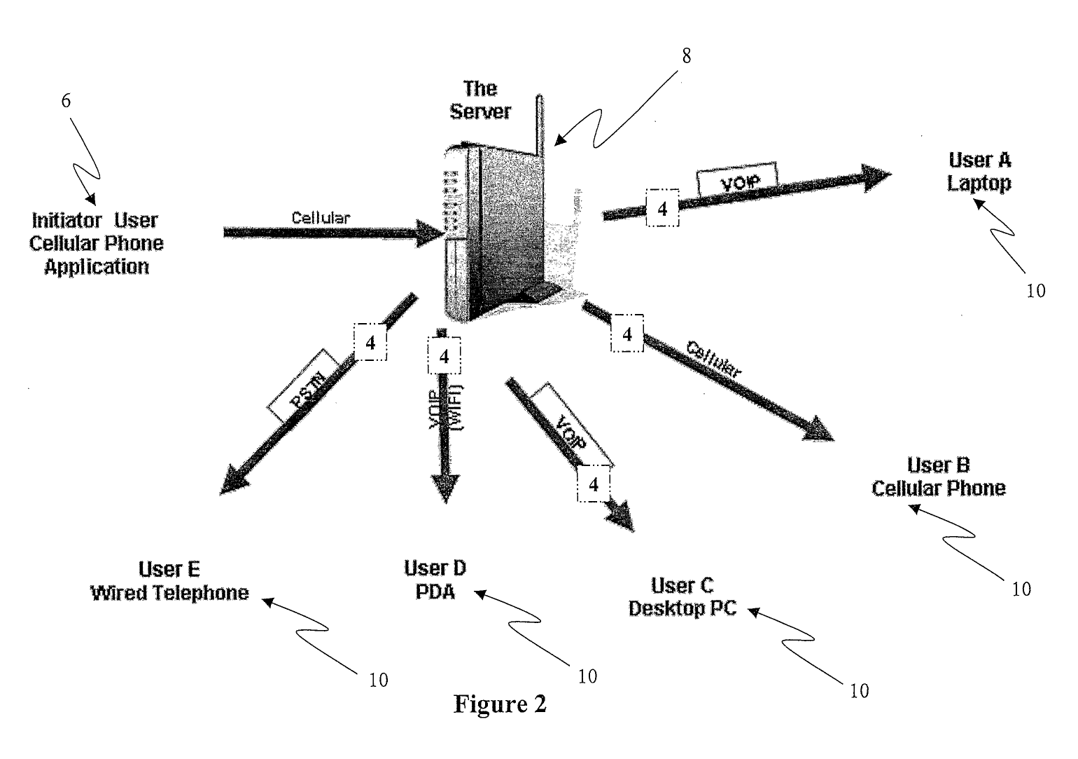

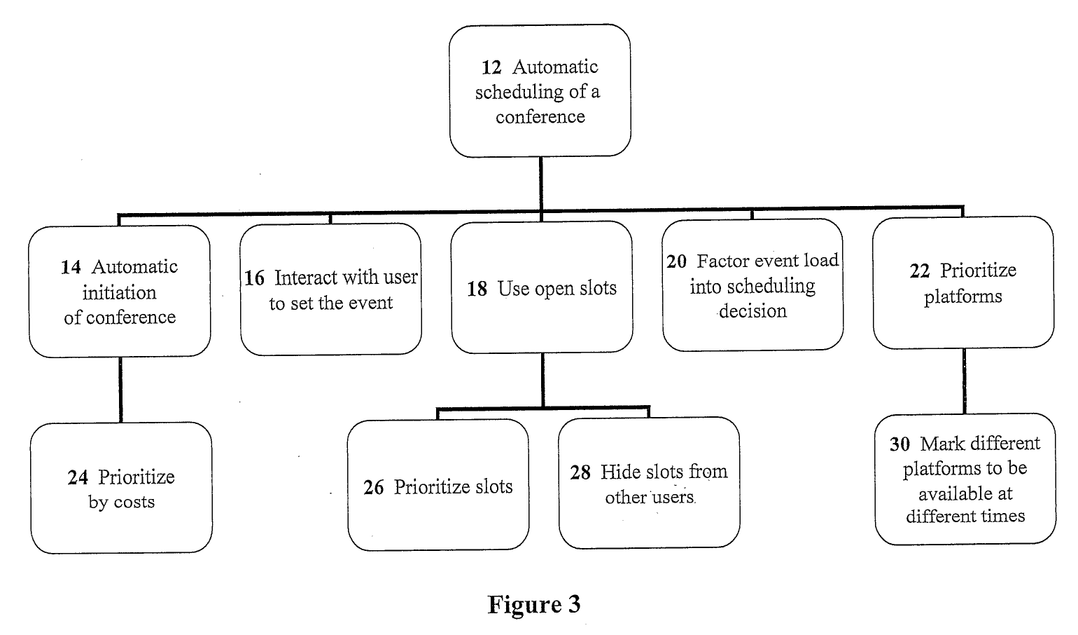

Users are able to register into server 8 to become an “initiator” of a new event via a web server installed in the public internet or in an internal intranet network. While initiator PCD 6 and IU PCDs 10 are depicted in FIG. 2 with different reference numerals, it should be understood that the devices are only differentiated to illustrate the example of the initiator. In another situation, an IU can initiate his/her own event using PCD 10. Reference will be made only to PCD 10 hereinafter.

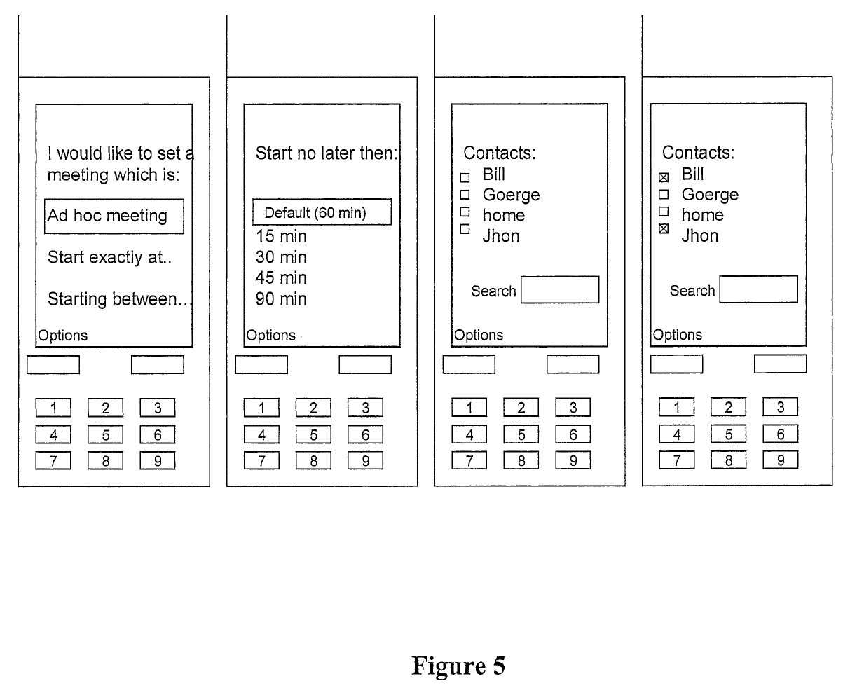

FIG. 5 is a simplified illustration of exemplary application menus for a mobile phone as the PCD, according to preferred embodiments of the present invention. The initiator is able to generate an interactive event request by using the contact list installed in the initiator's PCD 10 (or from a user database in server 8), mark the intended IUs (either users with or without an end-user application), set the preferred event-time method (e.g. ad-hoc, time interval, time-slot options, fixed time), set the preferred event medium, (e.g. voice, web, chat, video, face-to-face), set the preferred location, set the event duration, set the urgency of the event, and set the priorities of the IUs (e.g. manager is necessary participant and colleague is welcome, but not crucial).

The event request generated is delivered using a textual message mechanism (e.g. SMS, MMS, GPRS data exchanging, e-mail, and any data-transfer mechanism delivered over the internet or any other network). Only a few options are illustrated in FIG. 5. It is noted that FIG. 5 is used as an example in that any type of PCD can be used to interact with the system.

The event request is sent to server 8 (FIG. 4). Server 8 can then modify the request so the request is optimized according to the IU data (e.g. contextual and presence data) and the sending channel (e.g. it may decide to send the request to an IU through SMS only, or send the request to an IU with a PCD client application using all possible options provided by the initiator). Server 8 delivers the event request to each IU. The IUs do not require any kind of end-user application. However, if the IUs do have the end-user application, server 8 is able to ping the associated PCDs 10, and prioritize channels 4 according to a preset configuration (e.g. prioritizing PCDs that are connecting over the internet). The event request is received by PCDs 10 as a message (e.g. text or voice), only requiring the IU to accept or decline the event request. The IU is also able to mark the preferred channel 4 to be used.

If the event request is approved by all IUs, server 8 informs the initiator, and waits for final approval by the initiator to confirm the event details. If one or more IUs decline the suggested event time, server 8 informs the initiator, and waits for further instructions by the initiator. The initiator can decide that IUs that declined the event request are not critical participants for the event and approve the event details, or the initiator can instruct server 8 to ask the IUs that declined the event request when is the soonest time that the IUs are available to accept the event. This process is elaborated on below.

Once the event time has been set, the IUs receive confirmation. Before the event is about to take place, the IUs receive a notification informing them that the session is about to begin and asks the IUs to join the event. When the event is taking place, all participants are able to interact with each other. The initiator can also use a virtual whiteboard for presenting material. Each participant sees an indication showing who is speaking at any given time. The participants are able to share data during the event, even though each participant may be using a different device, and may be connected using different communication channels and networks.

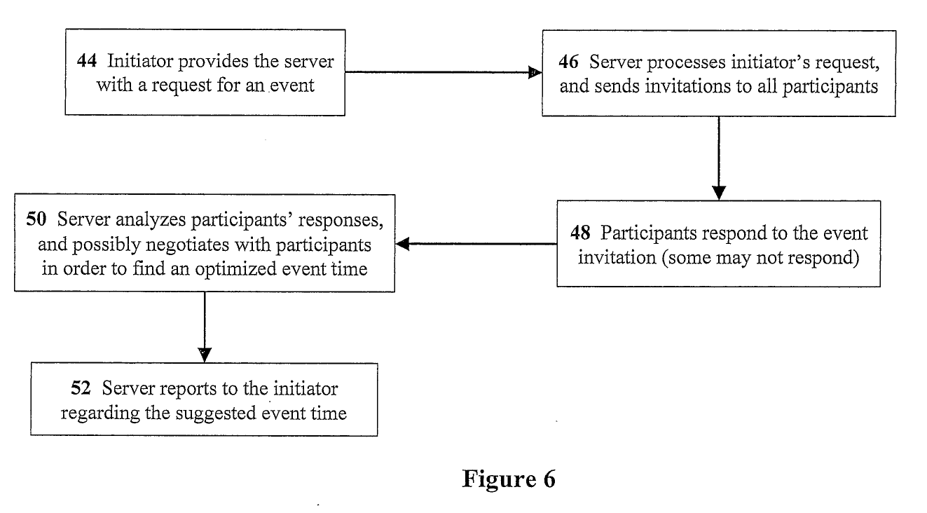

FIG. 6 is a simplified flowchart of the main processes in the system flow, according to preferred embodiments of the present invention. First, the initiator provides the server with a request for an event (Step 44). The server processes the initiator's event request, and sends invitations to all IUs (Step 46). The IUs respond to the event request (some may not respond) (Step 48). The server analyzes the IUs' responses, and possibly negotiates with the IUs in order to find an optimized event time (Step 50). The server reports to the initiator regarding the suggested event time (Step 52).

The initiator sets the expected time duration for the event with several options to decide when the event will take place. For any given event, the initiator chooses the most suitable option for the event. The options for setting the event time may include, but are not limited to, the following methods.
(1) Ad-hoc event: the initiator sends the request to IUs that he/she wants to interact with now. If the IUs accept, the event takes place. If not, the IUs can indicate when they are available as close to the present time as possible. The server receives the IUs' responses, analyzes the responses, and quickly sends a report to the initiator. Based on the report, the initiator decides what to do.
(2) Fixed-time event: the initiator chooses a fixed option for event time (e.g. today at 11:00), and the IUs reply whether they can attend or not.
(3) Multi-option event: the initiator chooses several event-time options (e.g. today at 10:00, 11:00, 14:00, 15:00, and tomorrow at 12:00 and 16:00). The IUs designate the preferred option, acceptable options, and unacceptable options for event time. The server analyzes the responses, and offers the initiator the optimal time slot for the event (optionally, with the other suggested times ranked).
(4) Open time-slot interval event: the initiator chooses a time-slot interval, and asks the IUs to designate when they are available during one time slot or several time-slot intervals. For example, the initiator wants to conduct a 20-minute event. The initiator chooses a time-slot interval (e.g. today, 10:00-12:00). The IUs designate when they are available in the time slot. The server analyzes the responses, and offers the initiator the optimal time slot for the event.
(5) 1-click event: the initiator just selects the IUs from his/her contact list without preparing formal invitation request. The IUs receive notification that the initiator wants to initiate an event. The IUs can accept or decline. If an IU accepts, the initiator can contact them now. If not, the system asks the IUs when they can be contacted.
(6) Call-activation event: The initiator directly calls the user without addressing a request. If the user is willing to accept the call, the call is connected. However, if the user does not accept the call, the system automatically sends the user an “on-the-fly” response template (via the server or the end-user application on the PCD) for designating when the user can take the call.
(7) Designated-response event: A user presets a response. The system automatically accepts any event for the user that meets the preset response criteria. Other IUs can see which time slots have been designated by the user.

Beside time optimization, server 8 can optimize other factors (e.g. device, network, application, location, calendar, presence, and mode). Server 8 can select the right factor to optimize based on the users' preferences, current status, and network conditions. User preferences can be designated in the following ways.
(1) Device: the user can set the PCD he/she prefers to use (e.g. mobile cellular phone, landline phone, PC, and PDA).
(2) Application: the user can set the communication applications he/she prefers to use (e.g. Skype, MS Messenger, Yahoo Messenger, AOL Instant Messenger, ICQ, Webex, and Google Talk).
(3) Network: the on-line event can take place on several different networks (e.g. PSTN telephony, mobile wireless networks, and/or VoIP networks). The server checks the current status of each network, selects, and switches accordingly during the event session.
(4) Calendar: the server has an option to synchronize with the users' calendars (e.g. MS Outlook, IBM Lotus, Google calendar). The server checks the preset appointments, and factors the information into the optimization process.
(5) Location: If the event is a face-to-face meeting, and a location is needed, the server helps to select the nearest available location. The location can be a conference room, an office of one of the IUs, a coffee shop, or a restaurant, for example. The server also sends details about the selected location.

Once the initiator has sent the event request, and approved the event, a notification message is sent to the IUs informing them of the event details. When the event is about to take place, a reminder is sent to all IUs in order to remind them that the event is about to start. The reminder gives them the required event details in order to log in to the event session (e.g. the phone number to call, or a reminder to expect to receive from the initiator or the conference bridge). Once the event session has commenced, the server will either expect all IUs to dial-in and connect to the event session, or the server will dial-out all the IUs to connect them, according to a pre-defined setting,

Any notification to registered users' PCDs can be performed using j2me push registry (jsr 118) mechanism, similar mechanisms in other platforms, or mechanism that are developed by the application-platform vendor or are based on the application-platform capabilities. SMS (or another messaging system) notification may be built with STK commands, making it easier for the users to handle. In application platforms that support running applications in the background (e.g. Brew/Symbian), the client application runs in the background, and is brought to the foreground only upon user request or a request that comes from the server that needs the user's attention. For users that do not have web access from their phones, data transfer to and from the client application is performed over SMS.

Returning to FIG. 4, IVR/DTMF module 40 can use speech-to-text technologies in order to recognize users' names (e.g. in a database or contact list), or the event to be initiated. After the scheduling phase, the system is able to arrange the collaboration phase by:
(1) reserve a conference room (e.g. web or voice) and send the details, or make the conference room contact the IUs;
(2) initiate a phone call for a one-on-one event; and

Server 8 has plug-ins modules for different collaboration platforms, and serves the users as a transparent gateway (GW) between various systems.

Scheduling module 36 has the following inputs and outputs:
(1) inputs:
   (a) receives an interpreted initiator's event request to invite participants to an ad-hoc/future event via connection with IUs' PCDs 10; and
   (b) receives an interpreted participants' response to an ad-hoc/future event via connection with IUs' PCDs 10; and
(2) outputs:
   (a) notifies the IUs for an event request/rescheduling request via connection with IUs' PCD 10; and
   (b) provides the initiator (or automatically chooses) an optimized event time based on the IUs' responses via communication with IUs' PCDs 10.

User-communication module 34 includes sub-modules responsible for the interpretation of initiators' event requests and responses to an event request. The inputs and outputs of the sub-modules include:
(1) IVR/DTMF module 40:
   (a) inputs:
      (i) receives a voice request for an event (from the initiator); and
      (ii) receives a voice/DTMF response for an event (from the IU); and
   (b) output:
      (i) interprets the voice/DTMF request/response into data that can be processed by scheduling module 36; and
(2) internet-communication module 22 (uses any communication protocol over the internet (e.g. SMTP (email), HTTP, WAP, and propriety communication protocols)):
   (a) input:
      (i) receives a request for an event (from the initiator); and
      (ii) receives a response for an event (from the IU); and
   (b) output:
      (i) interprets the request/response into data that can be processed by scheduling module 36; and
(3) device-specific communication module 42 (uses any communication protocol applicable to mobile phones which have to be carried over a cellular network (e.g. SMS and WAP Push)):
   (a) input:
      (i) receives a request for an event (from the initiator) via any component in the cellular network (e.g. SMSC);
      (ii) receives a response for an event (from the IU) via any component in the cellular network; and
      (iii) sends a notification to IUs for an event request/rescheduling; and
   (b) output:
      (i) interprets the request/response into data that can be processed by scheduling module 36.

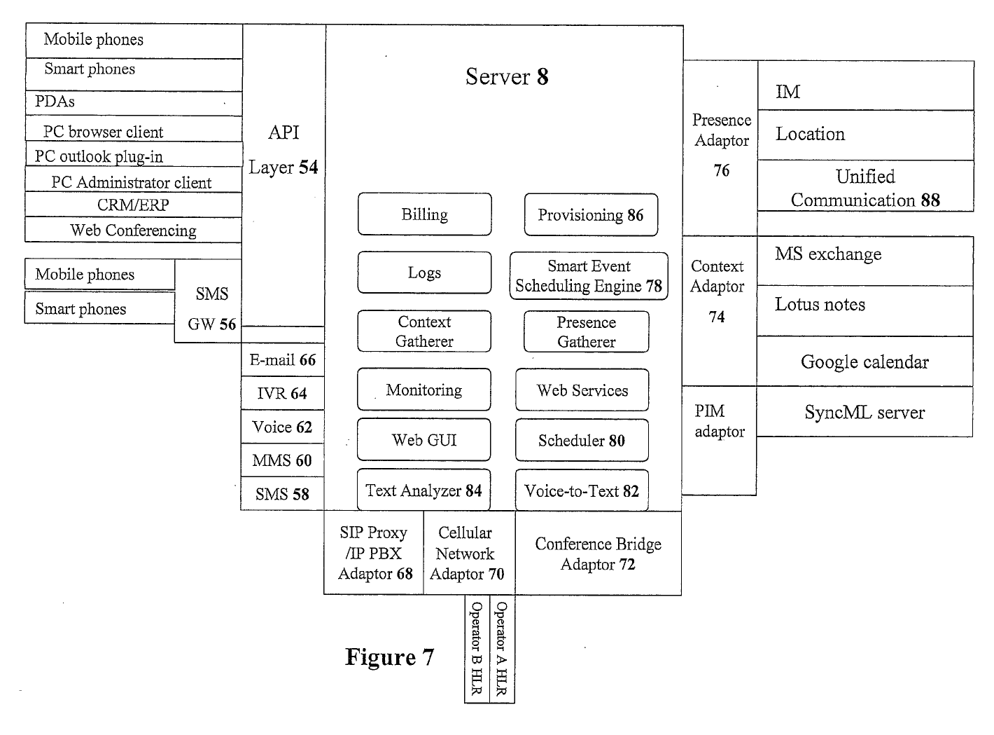

FIG. 7 is a simplified block diagram of the main modules of the system server, according to preferred embodiments of the present invention. An API layer 54 exposes the needed APIs for the users via XML SOAP/Web services. The users of API layer 54 are both client modules (e.g. mobile phone client) and internal server like the SMS GW adaptor. An SMS GW 56 receives data from clients by SMS, and passes the data to server 8 via server APIs. SMS GW 56 also sends back information to the users by SMS.

The components that server 8 interacts with the user include an SMS module 58 (i.e. details are sent by either regular text SMS, binary SMS or STK SMS), an MMS module 60 (i.e. text description together with an image of the current status), a voice module 62 (i.e. a voice message with the details are deposited in the IU's voice mail; the IU is directed to respond via one of the other channels), and a voice-to-text module 82 (i.e. a voice message with the details are translated by server 8, and sent to the IUs as text-message requests). Voice-to-text module 82 is also used to convert a recording of the event from a conference bridge to text so that users can have a text summary of the event.

Also shown in FIG. 7 is an IVR server 64 which can be an internal or third-party server used to interact with the users using DTMF and voice recognition. A user can “call” IVR server 64, and perform interactions with server 8. IVR server 64 may also use voice recognition in order to make interaction easier for the user For example, instead of asking the initiator, “For Sunday press 1, for Monday press 2 . . . ,” then, “Please enter the time,” and then “Please select the attendance from the following list,” the initiator can say “Ad-hoc meeting, no later than 14:00, attendance: Bob, Joe.” The voice recognition will use the data to set up the event.

Also shown in FIG. 7 is an e-mail module 66 (e.g. either regular text e-mail or a meeting e-mail is used to help set up an event). E-mail module 66 can be used together with a calendar plug-in module. Client applications (not shown) include: PCD client applications that provide a rich GUI interface (e.g. written in J2ME, Symbian, Brew, Win mobile, or embedded software), device browser applications (e.g. based on HTML, XHTML, and WAP), PC rich-GUI client-applications, PC thin-client applications (e.g. based on the PC browser using HTML, java script, FLASH, or Ajax), calendar plug-ins, and other third-party client applications (e.g. CRM, ERP, and web conferencing).

Also shown in FIG. 7 is an SIP proxy/IP PBX adaptor 68 used for having users call a central point, and the calls are directed to the best channel for the recipients. A cellular network adaptor 70 is used to hook in to data from a network operator (e.g. HLR, location, billing, and monitoring). A conference bridge adaptor 72 is used to: reserve a meeting room (if needed) after an event has been set, and retrieve data, that may be of interest to users, available via a web interface (e.g. meeting recordings and attendance list). A context adaptor 74 is used to hook in to external context data sources (e.g. Outlook, Lotus Notes, Google calendar, and other calendars), and to retrieve information from device calendars (either via the client, external SyncML, or similar PIM synchronization system).

Also shown in FIG. 7 is a presence adaptor 76 used to hook in to presence services (e.g. ICQ, MS Messenger, Google talk, Yahoo Messenger, and AOL Messenger) and location services. A smart-event scheduling engine 78 is used to calculate the best time for an event. A scheduler 80 is responsible for doing all periodic tasks (e.g. event reminder and “watch dog” for interacting with the users). A text analyzer 84 is used to analyze free-text messages, and also, if needed, use an OCR to convert handwriting to text. A provisioning module 86 is used to provision user, and to ensure users are recognized over different channels. A unified communication module 88 is used for enterprise-unified communication (e.g. Microsoft, Jabber, IBM, and Cisco).

The following parameter options can be implemented both in client application (e.g. J2ME, Symbian, Brew, Win Mobile, or any other VM or embedded platform), or HTML/XHTML/WAP in server 8.
(1) Choosing the event time:
   (a) ad-hoc;
   (b) starting exactly at . . . ;
   (c) starting between . . . ; and
   (d) several options . . .
(2) Subject of event.
(3) Choosing the event type:
   (a) voice conferencing;
   (b) web conferencing;
   (c) video conferencing;
   (d) mobile conferencing;
   (e) dial-in conferencing;
   (f) dial-out conferencing;
   (g) interactive chat; or
   (h) face-to-face (select the location).
(4) Duration of event.
(5) Urgency level (e.g. high, normal, and low).
(6) Initiator accesses contact list, and designates IUs.
(7) Initiator sends event request (via SMS over a wireless network or as message over a IP network).
(8) Application sends event request to the server.
(9) Application is linked by the internet and/or by the wireless network.
(10) Server sends event request to the IUs via e-mail message to internet users and via SMS to cellular phone users.
(11) IUs respond to event request; responses are sent to server.
(12) Server waits X minutes for responses.
(13) Server passes results to initiator (if initiator closes the application, the SMS will operate the application (i.e. WMA); if the application is open, it will ping the server every 30 seconds).
(14) Initiator decides on event status:
   (a) Confirm event without match with IUs' schedules;
   (b) Ask server to suggest alternative time; or
   (c) Cancel the event.
(15) If initiator asks to reset event, he will then wait another X minutes for responses.
(16) Following the initiator decision, a notification message is sent to IUs:
   (a) “The event is about to start within X minutes”;
   (b) “The event will take place at ______”; or
   (c) “The event has been canceled”.
(17) If “The event is about to start within X minutes” is selected, the initiator will be asked by the server:
   (a) If voice conferencing: “Do you want to supply a dial-in/dial-out conferencing bridge, or would you like to call IUs?”
      (i) if the service is provided by a third-party conferencing vendor: “Please set the audio conferencing.” (e.g. Polycom, Avaya, Nortel-Alcatel, Cisco, Microsoft, Asterik, Vapps, Skype, Jajah, Fring);
   (b) If web conferencing: “Please set the web conferencing” (e.g. Cisco/Webex, Microsoft LiveMeeting, Citrix Online/GoToMeeting, AT&T/Interwise, Comvenos, BeanYourScreen, FastViewr, Vyew, Yugma, Arel, IBM, Adobe Systems, iLinic, NetViewer, SabalCenta, Elliminate, Dialcom Networks, Web Dialogs, High-speed conferencing NVapps, and Genesys conferencing);
   (c) If video conferencing: “Please set the video conferencing” (e.g. Tandberg, Sony, VCON, Polycom, Oovoo, Qnext, and RadVision);
   (d) If chat conferencing: “please set the chat conferencing”; or
   (e) If face-to-face: “Please come to the location.”
(18) Following the initiator decision, a message to the IUs is sent, for example:
   (a) Voice conferencing;
   (b) “You should call number XXXXXX”;
   (c) “You should expect a call in X minutes”;
   (d) Web conferencing: “You should receive a web conferencing invitation”;
   (e) Interactive chat: will start as planned; and
   (f) Face-to-face: “You should arrive at the location.”
(19) The application is installed in different ways:
   (a) downloading from the server by using a PC, and copying the files to the cellular device via cellular-phone PC suite;
   (b) WAP surfing to the existing WML page in the server, selecting the cellular device, and downloading the file;
   (c) sending WAP push from the server to the cellular device of the user leading to the WML in the server; and
   (d) using a pure web-based application, and accessing it from the PCD via the internet.
(20) Other functionalities:
   (a) HTML pages which are equivalent to the application screens;
   (b) Sending requests via emails;
   (c) HTML pages where invited users will be happy to respond;
   (d) Receiving contact list from the J2ME application in order to present the familiar contacts list to the user;
   (e) Sending SMS interactive requests;
   (f) Sending push WAP; and
   (g) Administrative interface:
      (i) Login screen with username and password;
      (ii) Presenting all registered initiators;
      (iii) Creating/Editing initiator;
      (iv) Other functionalities to the J2ME;
      (v) Uploading contact list to the server;
      (vi) Setting context sources;
      (vii) Setting location sources; and
      (viii) Setting per user/group preferences.

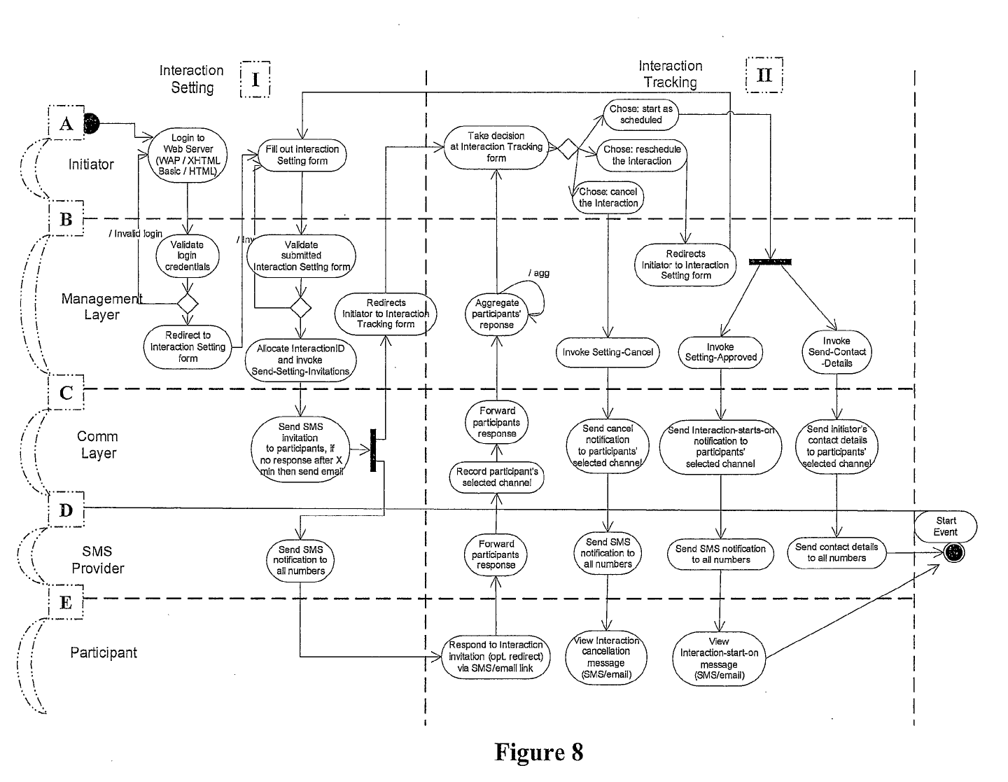

FIG. 8 is a simplified scheme showing the five layers of processing while setting up an event, according to preferred embodiments of the present invention. An initiator layer A operating from the initiator's PCD, a management layer B operating from server 8, a communication layer C operating from server 8, an SMS provider layer D operating from server 8, and a participant layer E operating from the IUs' PCDs. The scheme of FIG. 8 is divided into two regions: an interaction (i.e. event) setting region I and an interaction tracking region II.

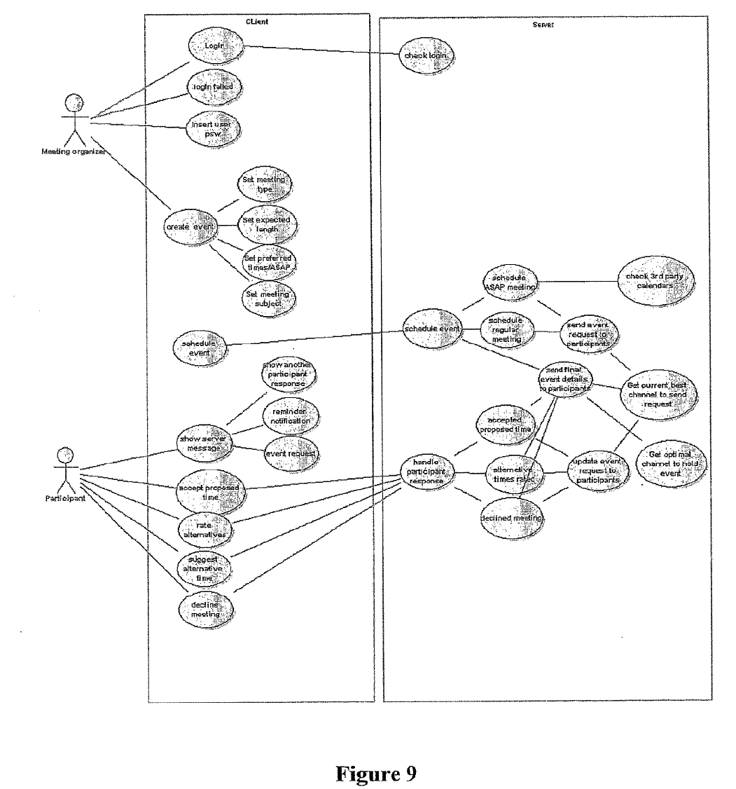

FIG. 9 is a simplified illustration of main use cases, according to preferred embodiments of the present invention. FIG. 9 is meant to depict the back-and-forth interaction that is managed by server 8. This process is performed by the initiator and a chain of IUs in the try-and-trail approach of the prior-art methods in which the involved parties can find themselves in a time-consuming and frustrating practice of what is known as “phone tag”. The present invention eliminates such a situation from occurring. A logical flow of the process steps is described below.

The present invention also enables the initiator to make a call to a pre-defined phone number of a conference bridge. The conference bridge requests from server 8 to get the event details for a user with identifier as found from the call data (e.g. the user msisdn on GSM/UMTS networks, or ESN on CDMA networks). Server 8 returns a list of event IUs and preferred channels for each IU. Server 8 also provides identifying credentials (e.g. Skype user and password for making VoIP calls in the Skype network). The conferencing bridge then starts to connect to each IU on the appropriate channel.

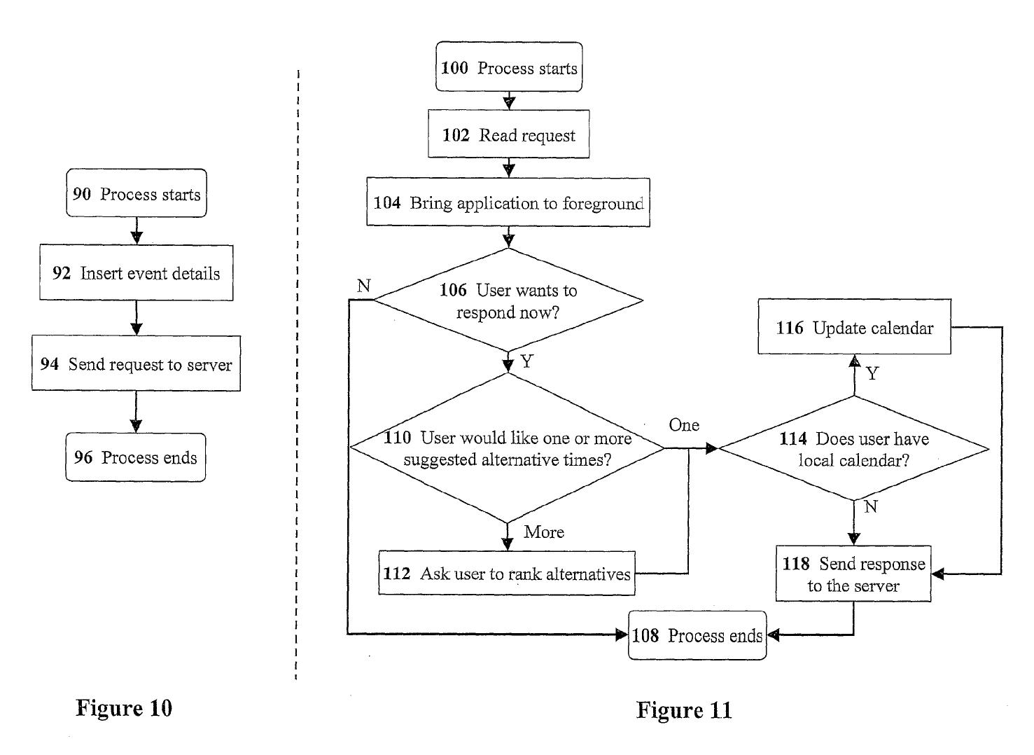

FIG. 10 is a simplified flowchart of the process steps for an initiator creating an event, according to preferred embodiments of the present invention. The initiator can start the process of creating an event from a variety of interfaces (e.g. a PCD browser, a PCD client application, SMS, MMS, a PC client application, an Outlook plug-in, a Lotus Notes plug-in, a PC web browser, and a third-party audio-, web-, or video-conferencing application) (Step 90). The initiator then inserts the event details (Step 92). Event details can include, for example: IUs (including who is optional and who is mandatory), suggested time/times/time slot, type of event (e.g. face to face, voice conference, and video conference), expected duration of event, and free text description of the event.

The initiator can designate next to an IU that “event will be held when this person is free”, so that once the designated IU has provided his/her preferred event time, the server will interact with other IUs and the initiator to set the event for the designated time slot. The initiator's GUI can include pre-defined templates. For example, the initiator can select the IUs for an event from his/her contact list/call log(e.g. missed calls, answered calls, and dialed numbers) using an client-application plug-in. Optionally, when selecting the event time, the initiator can see shared calendars of the IUs, as well as shared presence information. All items appear in the GUI in an intuitive form (e.g. a graphic with different colors for different contextual and presence states).

The server then sends the event request (Step 94). After sending the request, the initiator can dynamically see the IU responses if the initiator remains connected. Alternatively, the initiator can call a user directly without entering an event request. If the user is willing to accept the call, the call is connected. However, if the user does not accept the call, the system activates the client application on the PCD of the user to provide an on-the-fly template for responding when and how the user can take the call. The event creation process then ends (Step 96).

FIG. 11 is a simplified flowchart of the process steps for an IU receiving an event request, according to preferred embodiments of the present invention. After an event request is sent to IUs (Step 100), the client application reads the request (Step 102), the client application is brought to the foreground (Step 104). For IUs who receive the request on a mobile phone/PCD, the application is brought to the foreground via a application trigger (e.g. SMS push registry, proprietary application SMS, SIM Toolkit SMS, WAP push, and application on-line with the server but running in the background). For IUs who receive the request on a PC, the request can be received as a regular calendar event, a textual mail, or as proprietary pop-up window, for example.

IUs can respond to an event request when it is received (Step 106). If an IU chooses to respond at a later time, then the process is terminated (Step 108). If an IU chooses to respond when the request is received, the IU can provide one or more suggested alternative times (Step 110). There can be several types of replies (e.g. accept, decline, decline but suggest alternative time, tentative, and tentative but suggest alternative time). For multiple suggested times, the IU is asked to rank his/her preference of the alternatives (e.g. best, good, not available, or a scale of 1-10) for the event (Step 112).

If the event request set a time slot for the event should take place, the IUs should reply which times he/she is available and are most convenient for within the time slot. For example, for an the initiator who wants to conduct a 20-minute event, and chooses a time slot of today, 10:00-12:00, the IUs mark when they are available in the time slot. When suggesting alternative times, IUS can either mention a specific time for the event (e.g. 13:00-14:00) or provide a time slot when they are available (e.g. 13:00-17:30).

The client application then detects if there is a local calendar on the IU's PCD (Step 114). If there is a local calendar, it is updated (Step 116), the response is sent to the server (Step 118), and the process ends (Step 108).

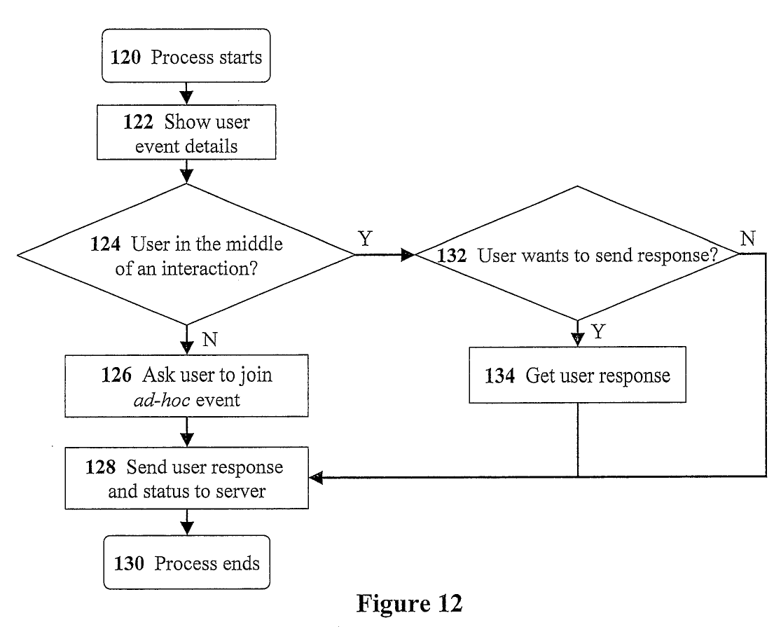

FIG. 12 is a simplified flowchart of the process steps for an IU receiving an ad-hoc event request, according to preferred embodiments of the present invention. The client application can recognize whether an IU is in the middle of an interaction. Information is received from the server which obtains the IU's status from the network (e.g. cellular, PSTN, or VoIP). The client application can recognize whether an IU is in the middle of a call by “listening” to the PCD microphone, or by using the PCD API to detect whether a call is in progress.

After an ad-hoc event request is sent to an IU (Step 120), the event details are shown to the IU (Step 122). The client application determines whether the IU is in the middle of an interaction or call (Step 124). If the IU is not in the middle of an interaction or call, the IU is asked to join the ad-hoc event (Step 126). The client application then sends the user response and status to the server (Step 128), and the process ends (Step 130).

If the IU is in the middle of an interaction or call, the IU can choose whether to send a response or not (Step 132). The client application is activated automatically, and lets the IU respond using an intuitive GUI. If the IU chooses not to respond, the client application sends the user status to the server (Step 128), and the process ends (Step 130). If the IU chooses to respond, the IU may respond with accept, decline, or decline but suggest alternative time, and may insert free text. The client application receives the user response (Step 134), sends the response and status to the server (Step 128), and the process ends (Step 130).

For IUs receiving the event request on a device without the client application but with a network connection (e.g. Wi-Fi, GPRS, UMTS, and CDMA), the request is presented in a WAP push format. The rest of the interaction is performed from a device browser. For IUs receiving the event request on a device without the client application and without a network connection, the request and response are handled using regular SMS or STK SMS. For regular SMS, the IU may insert his/her response in free text.

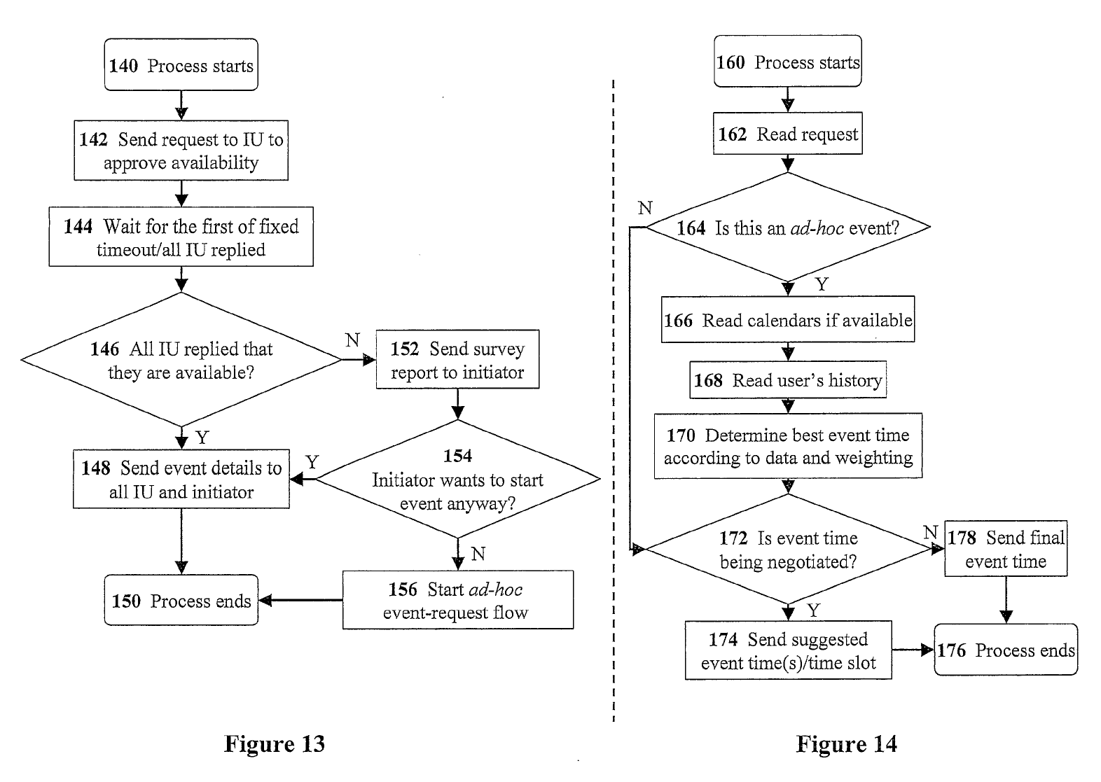

FIG. 13 is a simplified flowchart of the process steps for the server handling an ad-hoc event request, according to preferred embodiments of the present invention. After the server receives an ad-hoc event request (Step 140), the event request is sent to the IUs to approve availability (Step 142). The server waits for the first of a fixed timeout for all IUs to reply (Step 144). The server determines whether all IUs have replied that they are available (Step 146). If so, the event details are sent to the IUs and the initiator (Step 148), and the process ends (Step 150).

If not all IUs have replied that they are available, the server sends a survey report (i.e. collection of IU response and status) to the initiator (Step 152). The server waits to see whether the initiator wants to start the event anyway (Step 154). If so, the event details are sent to the IUs and the initiator (Step 148), and the process ends (Step 150). If not, an ad-hoc event-request flow is started (Step 156), and the process ends (Step 150). The ad-hoc event-request flow is described below with regard to FIG. 16.

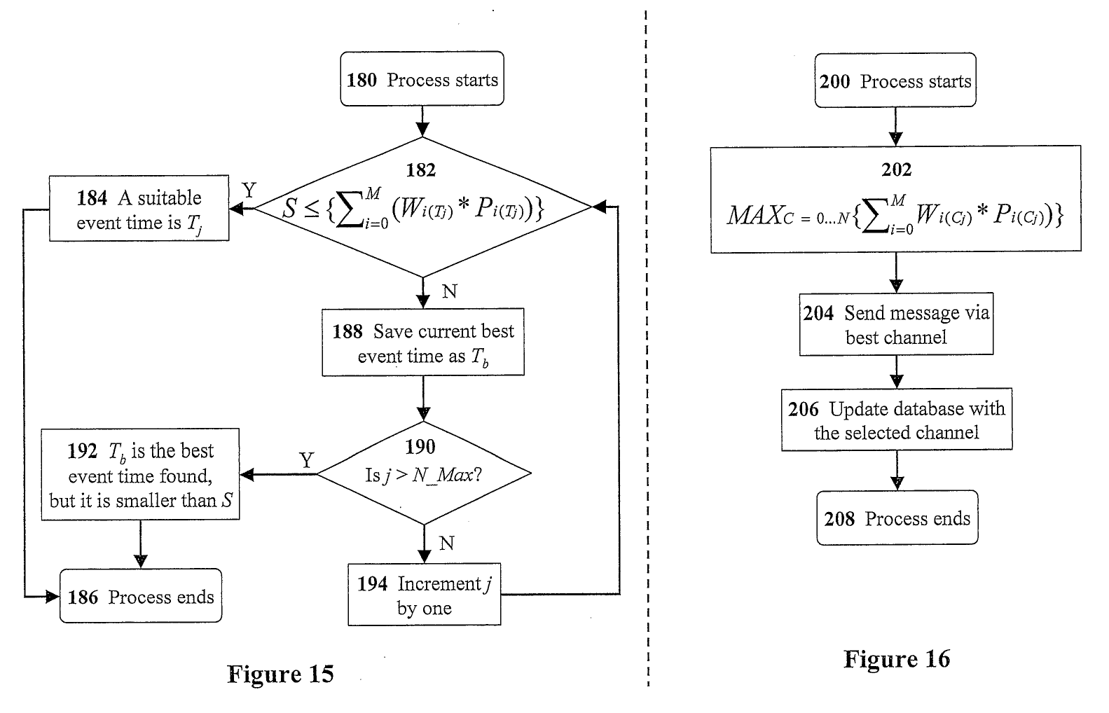

FIG. 14 is a simplified flowchart of the process steps for the server scheduling an event, according to preferred embodiments of the present invention. After the server receives an event request (Step 160), the event request is read by the server (Step 162). The server determines whether the event is an ad-hoc event (Step 164). If so, the server reads the IUs' calendars (if available) (Step 166), reads the IUs' history (i.e. presence information and their previous decisions regarding similar interactions) (Step 168), and determines the optimal event time according to the data and any parameter weighting (described in detail with regard to FIG. 15) (Step 170). If the event is not an ad-hoc event, the server jumps to Step 172.

The server then determines whether the event time is being “negotiated” (i.e. there is more then one alternative time or there is only one suggested time but the initiator did not indicate a fixed time) (Step 172). If so, the server sends the suggested event times or time-slot intervals (Step 174), and the process ends (Step 176). If the event time is not being negotiated, then the server sends the final event time (Step 178), and the process ends (Step 176).

Because of security and privacy reasons, users may not have access to some IUs' calendars (Step 166) and presence information (Step 168). Registered users are able to define which people/groups they allow/deny to see their calendars and presence. Also, users may expose their calendars/presence just for a specific event setup, and/or for specific initiators. Users who decide to share their calendars may also decide to which users they allow to see a “full view” (i.e. to see the event details when there is an event) and to which users they allow to see only a “limited view” (e.g. free, tentative, busy, in a call, vacation, and home).

FIG. 15 is a simplified flowchart of the process steps of an optimal-time algorithm for setting an ASAP event, according to preferred embodiments of the present invention. First, the algorithm is defined for the problem to be solved. Given T₀ is an event start time obtained from the event request (or the current time if none is obtained), the possible event times from T₀ will be T₁ . . . T_{N}, where Tᵢ=T₀+Int*i (the interval, Int, is a value taken from the server configuration for each user). For each time, we have M constraints, and for each constraint, a weight, W₀_{_{—}}_{Ti}, is assigned (W₁_{_{—Ti}} . . . W_{M}_{_{—}}_{Ti}, respectively). For each constraint, the probability of occurrence, P₀_{_{—}}_{Ti}, is assigned (P₁_{_{—}}_{Ti} . . . P_{M}_{_{—}}_{Ti}, respectively). The optimal time for the event then is:

$${MAX}_{T = 0 … N} \{ {\sum }_{i = 0}^{M} ( {W}_{i ( Tj )} * {P}_{i ( Tj )} ) \} .$$

For a success criterion, S, defined such that the event time is acceptable when S is met. For a maximum value N_Max for each event initiator in the system, the algorithm will run as follows. After the server receives an event request (Step 180), the server determines whether the success-criterion algorithm is met (Step 182). If so, then the server determines that Tⱼ is a suitable event time (Step 184), and the process ends (Step 186). If the success-criterion algorithm is not met, then the server saves the current best event time as T_{b} (Step 188). The server then determines whether j is greater than N_Max (Step 190). If so, the server determines that T_{b} is the best event time found, but it is smaller than S (Step 192), and the process ends (Step 186). If j is smaller than N_Max, the server increments j by one (so that the start-time check is Tⱼ) (Step 194), and the process returns to checking the success-criterion algorithm (Step 182).

Such analysis can also be performed using other algorithms (e.g. Bayesian logic, KNN, support vector machines (SVMs), logistic regression, and other machine-learning algorithms). Constraints can include:
(1) cost of event at a specific time (e.g. cost of conference room at specific hours and cost of air time);
(2) IU availability based on calendars;
(3) IU history (e.g. if a specific IU always declined events between 12:00 and 13:00, a negative weight with P close to 1 will be assigned for an event at this time);
(4) IU presence information and the history related to the presence;
(5) IU speed information (e.g. indicating that the IU is possibly driving, gathered from the client application installed on PCDs that have acceleration meters);
(6) IU location (e.g. if a face-to-face meeting is requested, and the IU is not in the office); and
(7) time of the day or day of the week.

The probability and weight values can be updated according to user history. In order to give more weight to some IUs, a scaling factor can be applied.

FIG. 16 is a simplified flowchart of the process steps for an optimal-channel algorithm for transmitting messages to users, according to preferred embodiments of the present invention. First, the algorithm is defined for the problem to be solved. Given N possible sending channels for a specific recipient C₀, C₁ᵢ . . . C_{N}, for each transmitting channel, we can define M constraints, and for each constraint, we a weight W₀_{_{—}}_{Ci} is assigned (W₁_{_{—}}_{Ci} . . . W_{M}_{_{—}}_{Ci}, respectively). For each constraint, the probability of occurrence, P₀_{_{—}}_{Ci}, is assigned (P₁_{_{—}}_{Ci} . . . Pₘ_{_{—}}_{Ci}, respectively). The optimal channel for transmitting the event then is:

$${MAX}_{C = 0 … N} \{ {\sum }_{i = 0}^{M} ( {W}_{i ( Cj )} * {P}_{i ( Cj )} ) \} .$$

For a channel criterion (MAX_{C}) defined as such, the channel-criterion algorithm for transmitting a message for each IU will run as follows. After the server receives an event request (Step 200), the server runs the channel-criterion algorithm (Step 202). The server then sends the message using the best channel that was determined from the algorithm (Step 204). The server updates the database with the selected channel (Step 206), and the process ends (Step 208).

Such analysis can also be performed using other algorithms (e.g. Bayesian logic, KNN, support vector machines (SVMs), logistic regression, and other machine-learning algorithms). Constraints can include:
(1) cost of a channel at a specific time (e.g. cost of sending SMS or MMS);
(2) IU history (e.g. if a specific IU only receives event requests at his/her desktop, the event request is sent by e-mail);
(3) IU presence information and the history related to the presence;
(4) IU speed information (e.g. gathered from the client applications installed on PCD that have acceleration meters); and
(5) IU location (e.g. if a face-to-face meeting is requested, and the IU is not in the office).

The probability and weight values can be updated according to user history. In the case that the user does not respond from a specific channel, the next best channel would be selected. In general, a mobile PCD is the initial default channel for IUs.

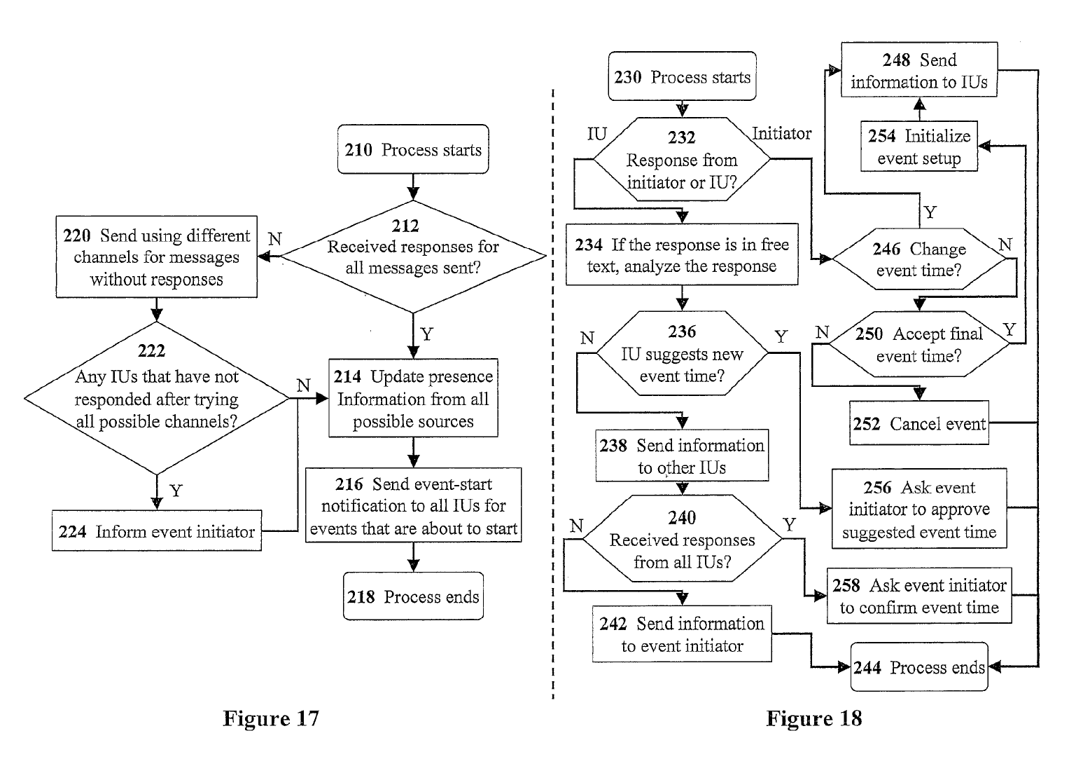

FIG. 17 is a simplified flowchart of the process steps for the server scheduler, according to preferred embodiments of the present invention. For every time interval that is determined in the server configuration, the process starts (Step 210), and the server determines whether all responses from the IUs have been received (Step 212). If so, the server updates the presence information from all possible sources (Step 214), sends an event-start notification to all IUs for events that are about to start (Step 216), and the process ends (Step 218).

If not all responses from the IUs have been received, the server sends the request again using different channels for requests without responses (Step 220). The server then determines whether there are any IUs that have not responded after trying all possible channels (Step 222). If so, the server informs the event initiator (to ask whether the initiator wants to hold the event anyway, cancel the event, or wait for the IU to respond) (Step 224), and continues with Steps 214, 216, and 218. If not, the process jumps to Steps 214, 216, and 218.

The server scheduler is responsible for performing all tasks that should be performed periodically. Some contextual and presence data may not be available in real time or the SLA from the provider is not acceptable, requiring data to be gathered periodically and saved in the system database. For example, an SLA with a contextual provider could be such that when a query is made for a specific user calendar, the maximum time for reply is two minutes (worst case scenario). Such a query could not be used by the system in real time. The system would have to hold the data cached in the database.

FIG. 18 is a simplified flowchart of the process steps for the server handling an event response, according to preferred embodiments of the present invention. After the server receives an event response (Step 230), the server determines whether the response is from an IU or the event initiator (Step 232). If the response is from an IU, the server checks the response for free text, and analyzes the text (Step 234). The server then determines whether the IU suggests a new event time (Step 236). If not, the server sends the response information to other IUs (Step 238), and then determines whether responses from all IUs have been received (Step 240). If not, the server sends the information to the event initiator (Step 242), and the process ends (Step 244).

If the response is from the initiator in Step 232, the server determines whether there is a change in event time (Step 246). If so, the server sends the response information to the IUs (Step 248), and the process ends (Step 244). If there is no change in the event time, the server determines whether the final event time was accepted (Step 250). If not, the server cancels the event (Step 252), and the process ends (Step 244). If the final event time was accepted, the server initializes the event setup (Step 254), and continues with Steps 248 and 244.

If the IU suggested a new event time in Step 236, the server asks the event initiator to approve the suggested event time (Step 256), and the process ends (Step 244). If the server received responses from all the IUs in Step 240, the server asks the event initiator to confirm the event time (Step 258), and the process ends (Step 244).

If the response is not in a fixed format (i.e. free text), the text is analyzed to extract the relevant data out of the text. For example, if the text reads, “No, maybe it is possible for you at 14:00,” the text analyzer will find keywords such as “no” and “possible at 14:00” using an algorithm (e.g. Boyer-Moore), and understand that the IU has declined the suggested time, and is suggesting a new time for the event at 14:00.

The reason for sending the response information to other IUs, even when the event time is not final yet (Step 238), is that when the IUs see positive responses to the event request from other IUs, it can help them to take their own decision. Initializing the event setup in Step 254 can include:
(1) reserving a voice/video/web conference room;
(2) reserving a meeting room; and/or
(3) updating data in the IUs' and initiator's calendars.

When asking the event initiator to confirm the event time (Step 258), the server provides the initiator with the maximum amount of information to make a decision (e.g. the possible times for the event, and which IUs have accepted for each time slot).

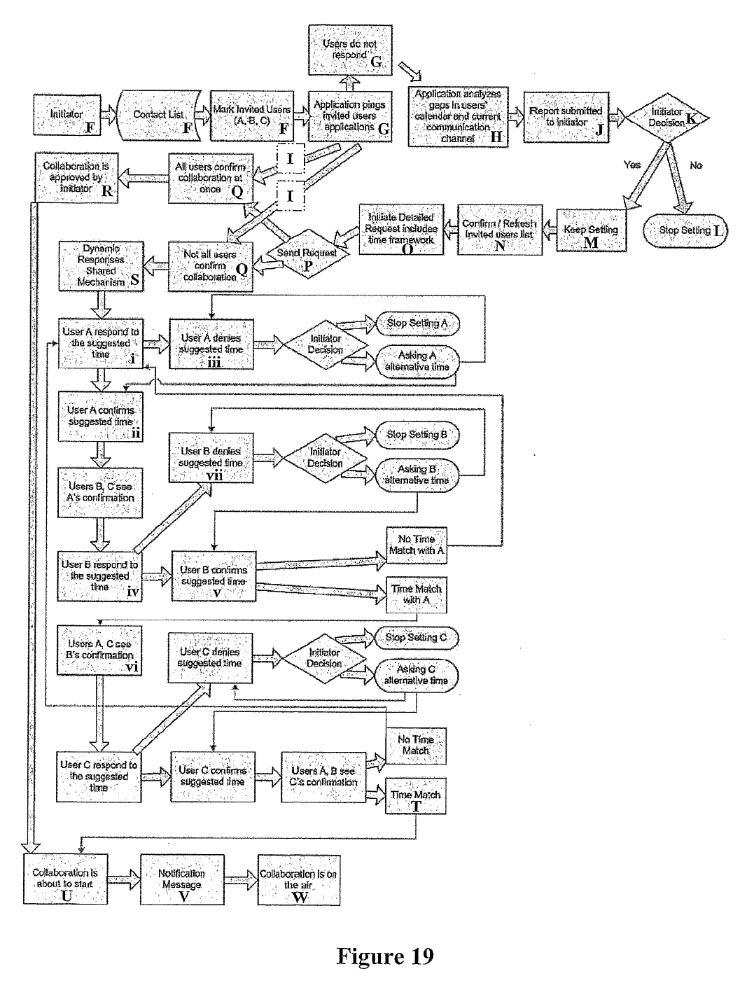

FIG. 19 is a simplified flowchart showing an example of the dynamic event-setting process of the system, according to preferred embodiments of the present invention. The system optimizes the event time by merging three variables:
(1) advance information generated by the server;
(2) IUs' indications; and
(3) dynamic interaction with invited users.

The process flow of FIG. 19 is as follows. The initiator marks the users to invite to the event (Step F). The server pings the “marked” users in order to analyze their situation before any event request has been addressed (Step G). The server can gather two kinds of information (Step H):
(1) the open gaps the users have in their calendars for all devices the system has in the database (e.g. Outlook, Lotus Notes, and even the calendar of a cellular phone); and
(2) the current communication channel status (e.g. during phone call, cell phone is switched off, in the middle of a Skype conversation, and PC is on).

Once users have been pinged, the IUs receive an initial brief indication that the initiator wants to coordinate an event with them (e.g. a green light with the name of the initiator), and are able to confirm immediately that they are ready for the event, or wait for a formal detailed request (Step I).

The initiator receives the IUs' response information via a graphic, for example, that describes the current status (e.g. which calendar the IUs have, and if there are any IUs that have confirmed the event before addressing a detailed request) (Step J). The initiator decides whether to move forward (Step K). If the initiator decides not to set the event, nothing will be done (Step L). If the initiator decides to move forward, a dynamic interaction with IUs commences (Step M).

The initiator confirms or refreshes the marked users, and picks users A, B, C (Step N). The initiator states the subject of the event, time framework, duration, urgency, event type (e.g. if face-to-face meeting, what is the location name) (Step O). The server sends the event request (Step P). Once the IUs receive the request, they can respond (Step Q). The initiator can decide at any point to approve the event, even if one or more IUs declined or did not reply (Step R).

Next, the DRSM is started (Step S). The responses are generated in a shared template/window by all IUs. The system tries to find the optimal match between the suggested event time of the initiator and the IUs' responses. A graphic provides the dynamic real-time responses. The first response by user A will be verified by the initiator's suggested time (Step i). If it matches, there will be an indication mark on the graphic template, shared and seen by all IUs, indicating that the initiator and user A are matched (Step ii). If user A marks a different time, then the initiator can either remove user A from the event, or confirm the new time, and then there will be a match indication seen by users B and C as well (Step iii).

In such a manner, user B can also respond at any time in order to find the optimal match (Step iv). User B can also select the matched time, or suggest an alternative time to be confirmed by the initiator (Step v). If user B selects the matched time, the graphic table will show all other IUs that user B is in the event as well (Step vi). If not, (i.e. user B chooses a different time slot, the initiator can again remove user B from the event, or confirm the new time, and a “new matched time” will appear in the shared template, waiting to receive responses from users A and C (Step vii).

The optimal “time match” is decided by the initiator. The initiator can decide to remove user A from the event, and have the event only with users B and C, or the initiator can decide to keep the event open until there is a 100% match, or cancel the event (Step T).

Once the optimal match has been confirmed by the initiator, the event can start immediately if it is an ad-hoc event. Or, if it is a later event, the IUs will receive a confirmation when the event is about to start. The event can also be synchronized with the IUs' calendars (Step U). A brief time before the event is about to begin, the IUs receive the notification (Step V), and the event takes place (Step W).

It is noted that the above scenario described a four-person event: an initiator and three IUs. However, the same process is suitable for any number of users. Furthermore, users A, B, and C are defined according to their chronological responses (i.e. the first user that responds is user A). If users respond simultaneously, then their designation is made according to their appearance in the contact list.

Another option to set the event is when the initiator does not mark the IUs, but addresses an event request that he/she wants to collaborate. The application will address the event request to all the users in the initiator's contact list, and find out which users are available now for the collaboration. Another option is for the event request to be performed only by pinging. The initiator marks the IUs, and a ping is automatically addressed to the IUs. The IUs see that the initiator is indicating that he/she wants to collaborate with them. In such a configuration, the application can be set such that the preferred ping will be to use an IP network, if available.

While the invention has been described with respect to a limited number of embodiments, it will be appreciated that many variations, modifications, and other applications of the invention may be made.

What is claimed is:

1. A method for electronically organizing an event among users having personal communication devices (PCDs), the method comprising the steps of:
(a) providing event details, defined by an initiator, of the event to a control unit, wherein said event details designate invited users and at least one suggested event time;
(b) transmitting, by said control unit, said event details in an event request to said invited users;
(c) indicating intentions, using the PCDs, of said invited users to participate in the event in responses from said invited users;
(d) designating, using the PCDs, a compatibility of said suggested event time with said invited users in said responses;
(e) dynamically interacting, by said control unit, with said initiator and said invited users to find an optimal event time; and
(f) conveying, by said control unit, said responses in a response report, wherein said response report indicates said optimal event time to said initiator.

2. The method of claim 1, wherein said event details further include at least one detail selected from the group consisting of: an event location, a preferred event type, a reminder time, a delay time, an invited-users list, an event location map, an attached document, an event-related media item, an event length, an event priority, and said responses, a preferred application, an available network, invited-user contact information, an event duration, a critical-participant list, an invited-user attendance priority, and a speaker-designation list.

3. The method of claim 1, wherein said at least one suggested event time includes at least one time option selected from the group consisting of: a fixed time, a time-slot interval, a selection of times, and an ad-hoc event time, an upon-free event time.

4. The method of claim 1, wherein said step of designating compatibility includes providing a ranking of said at least one suggested event times.

5. The method of claim 1, wherein said step of designating compatibility includes providing at least one alternative event time.

6. The method of claim 1, wherein said responses include at least one item selected from the group consisting of: a preferred communication channel, a preferred PCD, a alternative-time ranking, a suggested alternative time, free text, a voice memo, an alternative location, invited-user presence information, invited-user contextual information, an invited-user current status, and a preferred network.

7. The method of claim 1, wherein said step of transmitting includes transmitting using at least one transmittal item selected from the group consisting of: an SMS message, an MMS message, an e-mail message, an http packet, a tcp packet, a udp packet, a voice message, a video message, and an instant-messenger message.

8. The method of claim 1, wherein said responses are shared with all invited users upon being received by said control unit.

9. The method of claim 1, the method further comprising the step of:
(g) automatically activating a spontaneous response template, to be sent to said initiator, for a spontaneous invitee that is contacted, directly by said initiator, without an event request.

10. The method of claim 1, the method further comprising the step of:
(g) optimizing said event time based on an algorithm that factors in at least one response item from said responses.

11. The method of claim 1, the method further comprising the step of:
(g) prioritizing at least one communication channel for the event based on an algorithm that factors in at least one channel status.

12. The method of claim 1, wherein said step of interacting includes analyzing at least one factor selected from the group consisting of: said responses, invited-user histories, invited-user presence information, invited-user contextual information, invited-user speed, invited-user location, invited-user PCD data.

13. The method of claim 1, the method further comprising the step of:
(g) dynamically interacting with said initiator and said invited users to find an optimal event location.

14. The method of claim 1, the method further comprising the step of:
(g) notifying said invited users that the event is about to start.

15. The method of claim 1, the method further comprising the step of:
(g) recording, by said control unit, content from the event.

16. The method of claim 1, wherein said control unit is a device selected from the group consisting of: a system server and a PDC-installed client module.

17. The method of claim 1, the method further comprising the step of:
(g) presenting a map location for the event upon selecting a face-to-face event in said event details.

18. The method of claim 1, the method further comprising the step of:
(g) updating, by said control unit, said initiator of a PCD status of an invited user, wherein said PCD status is selected from the group consisting of: PCD busy, PCD off, PCD non-responsive, and PCD available, PCD unavailable, PCD on-vacation, PCD ready-to-receive, PCD in-meeting, PCD abroad, PCD home, and PCD driving.

19. The method of claim 9, wherein said spontaneous response template includes at least one response option selected from the group consisting of: accept call, delayed-accept call, and upon-free call.

20. A computer-readable storage medium having computer-readable code embodied on the computer-readable storage medium, the computer-readable code comprising:
(a) program code for providing event details, defined by an initiator, of an event to a control unit, wherein said event details designate invited users and at least one suggested event time;
(b) program code for transmitting, by said control unit, said event details in an event request to said invited users;
(c) program code for indicating intentions, using PCDs, of said invited users to participate in the event in responses from said invited users;
(d) program code for designating, using said PCDs, a compatibility of said suggested event time with said invited users in said responses;
(e) dynamically interacting, by said control unit, with said initiator and said invited users to find an optimal event time; and
(f) program code for conveying, by said control unit, said responses in a response report, wherein said response report indicates said optimal event time to said initiator.
